(19) United States
(12) Patent Application Publication
(10) Pub. No.: US 2026/0143063 A1
(43) Pub. Date: May 21, 2026

(54) VISUAL DELIVERY OF AUDIO CONTEXT FOR ASSISTIVE TECHNOLOGIES

(71) Applicant: Nagish Inc., New York, NY (US)

(72) Inventors: Tomer Aharoni, New York, NY (US); Alon Ezer, Hollywood, FL (US)

(73) Assignee: Nagish Inc., New York, NY (US)

(21) Appl. No.: 18/951,784

(22) Filed: Nov. 19, 2024

(51) Int. Cl. H04M 3/42; G10L 15/26

(52) U.S. Cl. CPC H04M 3/42391; G10L 15/26

(57) ABSTRACT

Visual cueing of audio context in an assistive audio call for a hard of hearing (HOH) participant includes establishing an assistive call with an HOH participant and a counterpart participant, receiving an audio stream from the counterpart participant and identifying speech audio within the audio stream and submitting the speech audio to a speech transformation engine in order to transform the speech audio to a visual form of the speech for consumption by the HOH participant. Visual cueing additionally includes processing a portion of the audio stream separate from the transformation of the speech audio to the visual form in order to identify an audio context of the audio stream. Finally, visual cueing includes displaying the visual form in a user interface to the assistive audio call and supplementing the visual form in the user interface with the visual cue of the audio context.

### BACKGROUND OF THE INVENTION

### Field of the Invention

The present invention relates to the technical field of assistive technologies, and more particularly to the supplementation of an alternative representation of audio in a communications session with a real time transformation of the audio.

### Description of the Related Art

Assistive technology is a term for assistive, adaptive, and rehabilitative devices for people with disabilities and the elderly. An assistive technology is any item, equipment, software program, or product used to increase, maintain, or improve the functional capabilities of persons with disabilities. Assistive technologies can range from the mechanical to the electro-mechanical to the electronic to pure software, and include everything from prosthetics to computer programs. Assistive technologies have been known to help those who have difficulty speaking, typing, writing, remembering, pointing, seeing, hearing, learning, walking, and many other things. To that end, different disabilities require different assistive technologies.

Those who are deaf, “hard of hearing” or “HoH” require specific assistive devices in order to function at a near equivalent level to those without hearing loss. Traditional assistive technologies for people with hearing loss include electronic hearing aids and in more sophisticated instances, cochlear implants. For many who are hard of hearing, the greatest challenge is communicating with those without hearing loss by means of communicative mechanisms including the traditional telephone or mobile phone, or in more modern instances, in an audio or video conference. As to the former, assistive devices such as a relay service allow the party to the conversation who is hard of hearing to read a real-time text transcript of the speech of the other party to the conversation and, optionally, to respond in text which then can be text-to-speech (TTS) processed into audio.

As to the latter, Internet-enabled assistive devices capitalizing on automated speech recognition are relatively new to the marketplace and are a direct response to the recent migration to remote meetings facilitated by virtual meeting platforms. Such assistive devices generally provide real-time or near real-time transcription of audio on a phone call using a speech recognition engine. However, while automated speech recognition is functionally equivalent to manual transcription from a word error rate perspective, it is widely understood that it is an imperfect mechanism and fairs poorly in conveying the context of the language of speech. To truly have accuracy in translation of speech while preserving some understanding of the context of delivery of the speech, those who are deaf rely upon the long-standing assistive tool of live sign language translation, while those who are hard of hearing have no other option. Yet, live sign language translation neglects to provide a true context of the audio such as the tone of a counterpart participant to the call, or the nature of background noise to the call.

### BRIEF SUMMARY OF THE INVENTION

Embodiments of the present invention address technical deficiencies of the art in respect to assistive call processing. To that end, embodiments of the present invention provide for a novel and non-obvious method for visual cueing of audio context in an assistive audio call for a HOH participant. Embodiments of the present invention also provide for a novel and non-obvious computing device adapted to perform the foregoing method. Finally, embodiments of the present invention provide for a novel and non-obvious data processing system incorporating the foregoing device in order to perform the foregoing method.

In one embodiment of the invention, a method for visual cueing of audio context in an assistive audio call for a HOH participant is provided. The method includes establishing an assistive call with an HOH participant and a counterpart participant, receiving an audio stream from the counterpart participant and identifying speech audio within the audio stream and submitting the speech audio to a speech transformation engine in order to transform the speech audio to a visual form of the speech for consumption by the HOH participant. For instance, the speech audio can be submitted to a speech recognition engine from which captioned text can be returned in textual form for consumption by the HOH participant.

The method additionally includes processing a portion of the audio stream separate from the speech transformation of the speech audio in order to identify an audio context and matching the audio context to a visual cue. In different aspects of the embodiment, the audio context can vary as set forth herein:
a determination of one of a male voice and a female voice.
a determination of a type of background noise (e.g. background music, a dog barking, or a baby crying).
a volume level of the speech audio indicative of tone.
A sentiment analysis by a sentiment analysis engine to convey feelings such as anger, joy, and lough.

Finally, the method includes displaying the visual form in a user interface to the assistive audio call and supplementing the visual form in the user interface with the visual cue of the audio context. In other aspects of the embodiment, the visual form can vary as set forth herein, including captioned text speech recognized from the speech audio in the audio stream.

In another embodiment of the invention, a data processing system is adapted for visual cueing of audio context in an assistive audio call for a HOH participant. The system includes a host computing platform with one or more computers, each having memory and one or processing units including one or more processing cores. The system also includes an assistive call processing gateway executing in the host computing platform managing an assistive call with an HOH participant and a counterpart participant by receiving an audio stream from the counterpart participant and identifying speech audio within the audio stream, submitting the speech audio to a speech transformation engine coupled to the host computing platform in order to transform the speech audio to a visual form of the speech for consumption by the HOH participant, and displaying the visual form in a user interface to the assistive audio call.

Importantly, the system includes an audio context supplementation module. The module includes computer program instructions enabled while executing in the memory of at least one of the processing units of the host computing platform to process a portion of the audio stream separate from the transformation of the speech audio in order to identify an audio context within the audio stream, match the audio context to a visual cue and supplement the visual form in the user interface with the visual cue of the audio context. In this way, the technical deficiencies of conventional assistive processing for HOH call participants are overcome owing to visual presentation of detected context of a call that otherwise would not be apparent to the HOH call participant lacking the ability to detect the audible cues of the audio context.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration reflecting different aspects of a process of visual cueing of audio context in an assistive audio call for a HOH participant;

FIG. 2 is a block diagram depicting a data processing system adapted to perform one of the aspects of the process of FIG. 1; and,

FIG. 3 is a flow chart illustrating one of the aspects of the process illustrated in FIG. 1.

### DETAILED DESCRIPTION OF THE INVENTION

Embodiments of the invention provide for visual cueing of audio context in an assistive audio call for a HOH participant. In accordance with an embodiment of the invention, speech audio can be recognized within an audio stream processed within an assistive call processing gateway processing a call between an HOH participant and a counterpart participant and transformed into a visual form presentable to the HOH participant. However, in supplement to the speech audio, an audio context to the call can be determined by detecting in a portion of the audio stream a known context. Thereafter, the known context can be matched to a visual cue which can be presented in supplement to the visual form of the speech audio. In this way, the HOH participant not only can comprehend the text of the speech audio in the visual form, but also the HOH participant can comprehend the audio context in which the speech audio is provided by the counterpart participant.

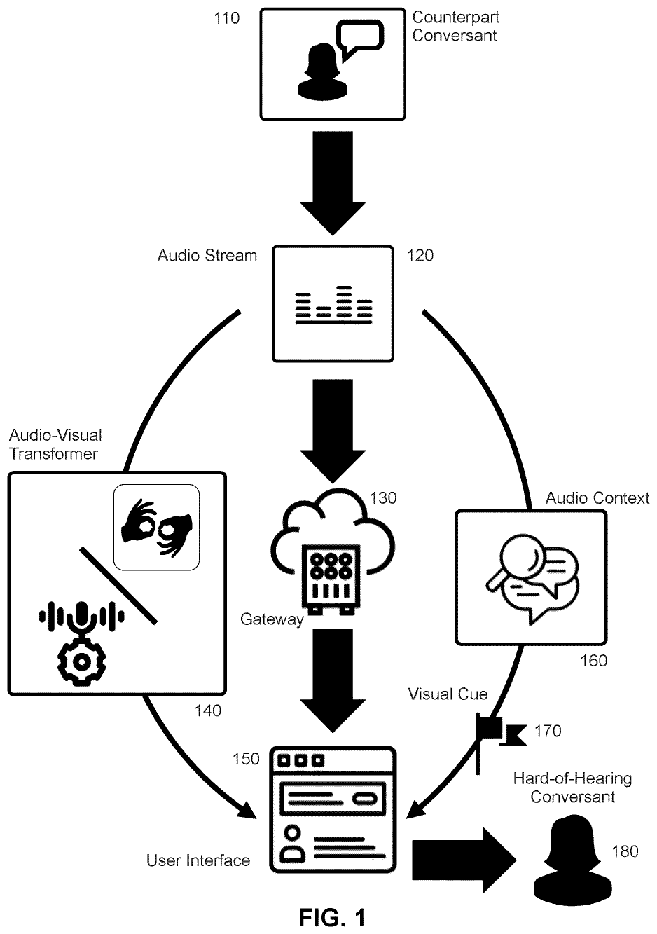

In illustration of one aspect of the embodiment, FIG. 1 pictorially shows a process of visual cueing of audio context in an assistive audio call for a HOH participant. As shown in FIG. 1, a data communications conference is established by an assistive cloud service 130 providing a gateway as between an HOH conversant 180 and a counterpart conversant 110. In the course of the data communications conference, the assistive cloud service 130 receives an audio stream 120 reflective of an audible contribution by the counterpart conversant 110 to the data communications conference. Responsive to the audio stream 120, the assistive cloud service 130 transforms portions of the audio stream 120 corresponding to speech audio into a visual form presentable in a user interface 150 to the assistive cloud service 130 for consumption by the HOH conversant 180.

Of note, the assistive cloud service 130 additionally processes the audio stream 120 to identify therein, an audio context 160. In this regard, the assistive cloud service 130 can select portions of the audio stream 120 for submission to analysis logic such as an audio pattern recognition logic block, a sentiment analysis module, or a deep neural network, in order to recognize from the selected portions, an audio context 160 such as the presence of and identification of a background noise such as a dog barking, baby crying, thunder, traffic and the like. Alternatively, the audio context 160 can include a sentiment of, or emotive force by the counterpart conversant 110 evident from the selected portions, the former being determined by sentiment analysis logic and the latter being determined by signal amplitude of the selected portions. As even a further alternative, the audio context 160 can include a determination by pattern matching of a gender, nationality, ethnicity or age of the counterpart conversant 110.

Once the assistive cloud service 130 has determined the audio context 160 from the selected portions of the audio stream 120, the assistive cloud service 130 can match the audio context 160 to a visual cue 170 such as an icon, an animation graphic, pre-specified annotative text, or other graphical symbol. Then, the assistive cloud service 130 can include the visual cue 170 in the user interface 150 in connection with the presentation of the user interface 150 to the HOH conversant 180. In this way, the HOH conversant 180 can enjoy a visual understanding of the audio context 160 present in the speech audio visually presented within the user interface 150 that otherwise would have been obscured owing to the transformation of the speech audio to the transformed visual form of the speech audio.

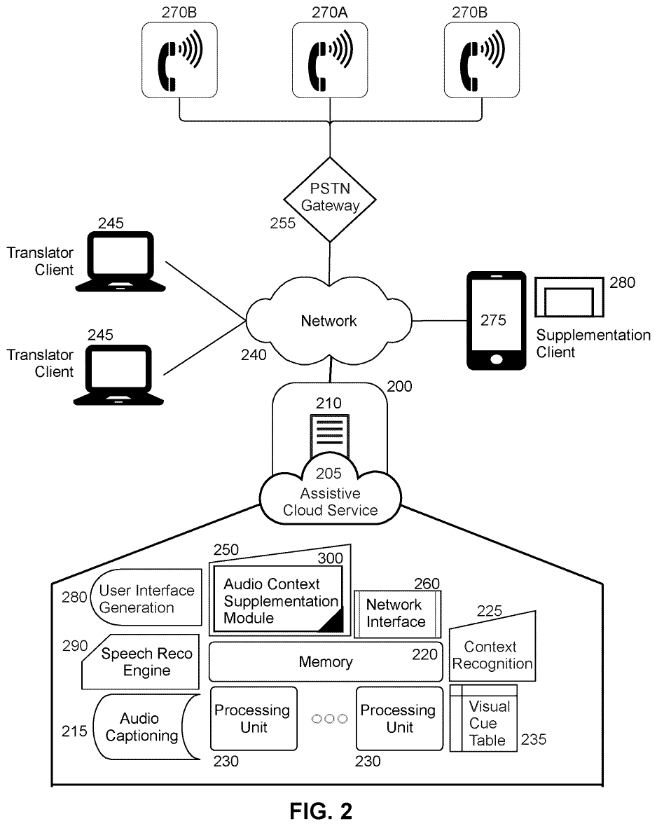

Aspects of the process described in connection with FIG. 1 can be implemented within a data processing system. In further illustration, FIG. 2 schematically shows a data processing system adapted to perform visual cueing of audio context in an assistive audio call for a HOH participant. In the data processing system illustrated in FIG. 1, a host computing platform 200 is provided. The host computing platform 200 includes one or more computers 210, each with memory 220 and one or more processing units 230. The computers 210 of the host computing platform 200 (only a single one of the devices 210 shown for the purpose of illustrative simplicity) can be co-located within one another and in communication with one another over a local area network, or over a data communications bus.

The computers 210 of the host computing platform 200 further can include a network interface 260 adapted to manage data communications with programmatic logic executing in the memory 220 by the processing units 230 of the computers by way of a data communications network 240. To that end, the host computing platform 200 is configured for communicative coupling by way of the network interface 260 to a public switched telephone network (PSTN) gateway 255 through which programmatic logic of the host computing platform can interact with different telephonically enabled computing telecommunications devices connected to the PSTN gateway 255 through a telecommunications network. As well, the host computing platform is configured for communicative coupling by way of the network interface 260 to different remote client devices 245 associated with respectively different sign language translators. Finally, the host computing platform 200 is communicatively coupled to a smartphone 275 over the data communications network 240.

The computer 210 supports the operation of an assistive cloud service 205 through the deployment of a supplementation client 290 into a remotely communicatively coupled smartphone 275. A user interface generation module 280 of the assistive cloud service 205 defines a user interface in the computer 210 for presentation in the supplementation client 280 of the smartphone 275 associated with a HOH participant to a conversation with a counterpart conversant in telephonically coupled one of the telecommunications devices 270A, 270B, 270C. Through the user interface of the supplementation client 290, the assistive cloud service 205 establishes a mediated conversation between the smartphone 275 of the HOH conversant and the telephonically coupled one of the telecommunications one of the telecommunications devices 270A, 270B, 270C of the counterpart conversant, by providing a visual form of speech audio within an audio stream transmitted by the counterpart conversant to the HOH conversant.

In one aspect of the embodiment, the visual form is transformed from the speech audio by a communicatively integrated one of the translator clients 245 receiving the speech audio and responding to the assistive cloud service 205 over the data communications network 240 with a video image of a sign language translation of the speech audio. The computer 210 also include an audio captioning module 215 configured to process audio of the conference into captioned text, for instance through the operation of a speech recognition engine, for ultimate display in concert with a view to the conference in the supplementation client. Notably, a computing device 250 including a non-transitory computer readable storage medium can be included with the data processing system 200 and accessed by the processing units 230 of one or more of the computers 210.

Notably, a computing device 250 including a non-transitory computer readable storage medium can be included with the data processing system 200 and accessed by the processing units 230 of one or more of the computers 210. The computing device stores 250 thereon or retains therein a program module 300 that includes computer program instructions which when executed by one or more of the processing units 230, performs a programmatically executable process for visual cueing of audio context in an assistive audio call for a HOH participant. Specifically, the program instructions during execution direct context recognition logic 225 to process the audio stream of the mediated conversation between the HOH conversant and the counterpart conversant in order to determine an audio context of the mediated conversation.

For instance, the context recognition logic 225 can submit the speech audio portion of the audio stream to a remotely disposed sentiment analysis service over the data communications network 240 in order to receive in return a textual sentiment for the speech audio which the context recognition logic 225 then assigns as the audio context. As another example, the context recognition logic 225 can temporally or spectrally analysis an audio signal present in the audio stream in order to determine pitch and amplitude to identify the manner in which the speech audio is delivered as the audio context, e.g. whispering, shouting, speaking loudly, speaking excitedly, etc. As yet another example, the context recognition logic 225 can subject the audio signal present in the audio stream to a convolutional neural network (not shown) trained to identify sounds associated with specific sound sources, such as a dog barking, baby crying, tea pot whistling, phone ringing, and the like in order to assign an audio context as a specific background noise.

Once the context recognition logic 225 has identified the audio context of the audio stream, the context recognition logic 225 cross-references a visual cue table 235 in the memory 220 in order to match the identified audio context to a specific visual cue such as a textual representation of the identified audio context, e.g. “baby crying”, “speaker whispering”, “speaker angry”, “dog barking”, or an iconographic representation of a sentiment, e.g. a laughing face emoji or a dog barking emoji. The context recognition logic 225 then provides the matched visual cue to the user interface generation module 280 for inclusion in the user interface for display in the supplementation client 290 of the smartphone 270A of the HOH conversant.

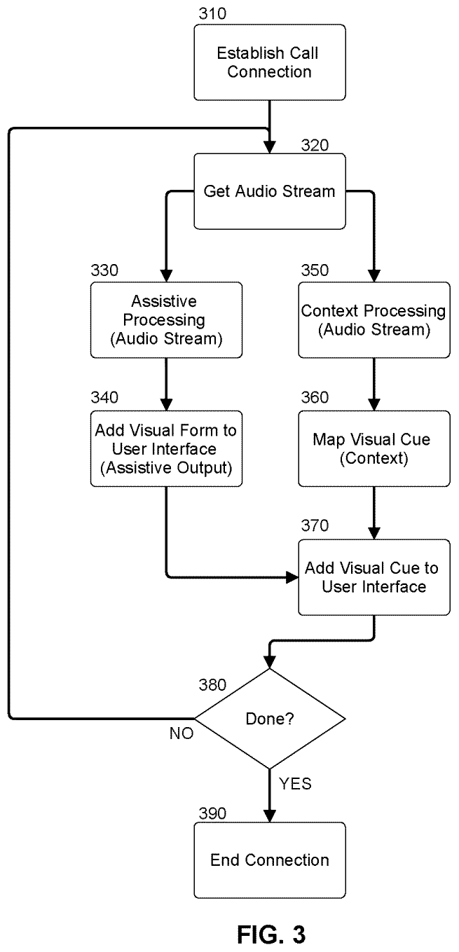

In further illustration of an exemplary operation of the module, FIG. 3 is a flow chart illustrating one of the aspects of the process of FIG. 1. Beginning in block 310, an assistive cloud service establishes a call connection between an HOH conversant and a counterpart conversant. Thereafter, the assistive cloud service acquires an audio stream originating with the counterpart conversant and directed to the HOH conversant. In block 330, the assistive cloud service performs assistive processing of the audio stream by transforming the speech audio within the audio stream into a visual form of the speech audio, such as by way of a video of a sign language translator signing the speech audio within the video, or by way of the generating captions by a speech recognition engine performing speech recognition upon the speech audio. Subsequently, in block 340, the assistive cloud service adds the visual form to a user interface for rendering in an supplementation client of the HOH conversant.

Concurrent to the assistive processing of the speech audio, in block 350, the audio stream is subjected to context processing in order to identify an audio context of the audio stream. Thereafter, in block 360, the identified audio context is mapped to a visual cue representative of the identified audio context and in block 370, the mapped visual cue is added to the user interface in supplement to the visual form of the speech audio. In decision block 380, if an additional audio stream is provided for assistive processing, the process returns to block 320. When no further audio streams are provided for assistive processing, the connection between the HOH conversant and the counterpart conversant terminates in block 390.

Of import, the foregoing flowchart and block diagram referred to herein illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

More specifically, the present invention may be embodied as a programmatically executable process. As well, the present invention may be embodied within a computing device upon which programmatic instructions are stored and from which the programmatic instructions are enabled to be loaded into memory of a data processing system and executed therefrom in order to perform the foregoing programmatically executable process. Even further, the present invention may be embodied within a data processing system adapted to load the programmatic instructions from a computing device and to then execute the programmatic instructions in order to perform the foregoing programmatically executable process.

To that end, the computing device is a non-transitory computer readable storage medium or media retaining therein or storing thereon computer readable program instructions. These instructions, when executed from memory by one or more processing units of a data processing system, cause the processing units to perform different programmatic processes exemplary of different aspects of the programmatically executable process. In this regard, the processing units each include an instruction execution device such as a central processing unit or “CPU” of a computer. One or more computers may be included within the data processing system. Of note, while the CPU can be a single core CPU, it will be understood that multiple CPU cores can operate within the CPU and in either instance, the instructions are directly loaded from memory into one or more of the cores of one or more of the CPUs for execution.

Aside from the direct loading of the instructions from memory for execution by one or more cores of a CPU or multiple CPUs, the computer readable program instructions described herein alternatively can be retrieved from over a computer communications network into the memory of a computer of the data processing system for execution therein. As well, only a portion of the program instructions may be retrieved into the memory from over the computer communications network, while other portions may be loaded from persistent storage of the computer. Even further, only a portion of the program instructions may execute by one or more processing cores of one or more CPUs of one of the computers of the data processing system, while other portions may cooperatively execute within a different computer of the data processing system that is either co-located with the computer or positioned remotely from the computer over the computer communications network with results of the computing by both computers shared therebetween.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for visual cueing of audio context in an assistive audio call for a deaf or a hard of hearing (HOH) participant comprising:
establishing an assistive call with an HOH participant and a counterpart participant;
receiving an audio stream from the counterpart participant and identifying speech audio within the audio stream;
submitting the speech audio to a speech transformation engine in order to transform the speech audio to a visual form of the speech for consumption by the HOH participant;
processing a portion of the audio stream separate from the transformation of the speech audio to the visual form in order to identify an audio context of the audio stream;
matching the audio context to a visual cue;
displaying the visual form in a user interface to the assistive audio call; and,
supplementing the visual form in the user interface with the visual cue of the audio context.

2. The method of claim 1, wherein the audio context is a determination of one of a masculine voice and a feminine voice.

3. The method of claim 1, wherein the audio context is a determination of a type of background noise.

4. The method of claim 1, wherein the audio context is a volume level of the speech indicative of tone.

5. The method of claim 1, wherein the audio context is a sentiment produced by a sentiment analysis engine.

6. The method of claim 1, wherein the visual form is captioned text speech recognized from the speech audio in the audio stream.

7. A data processing system adapted for visual cueing of audio context in an assistive audio call for a hard of hearing (HOH) participant, the system comprising:
a host computing platform comprising one or more computers, each with memory and one or processing units including one or more processing cores;
an assistive call processing gateway executing in the host computing platform managing an assistive call with an HOH participant and a counterpart participant by receiving an audio stream from the counterpart participant and identifying speech audio within the audio stream, submitting the speech audio to a speech transformation engine coupled to the host computing platform in order to transform the speech audio to a visual form of the speech for consumption by the HOH participant, and displaying the visual form in a user interface to the assistive audio call; and,
an audio context supplementation module comprising computer program instructions enabled while executing in the memory of at least one of the processing units of the host computing platform to perform:
processing a portion of the audio stream separate from the transformation of the speech audio to the visual form in order to identify an audio context of the audio stream;
matching the audio context to a visual cue; and,
supplementing the visual form in the user interface with the visual cue of the audio context.

8. The system of claim 7, wherein the audio context is a determination of one of a masculine voice and a feminine voice.

9. The system of claim 7, wherein the audio context is a determination of a type of background noise.

10. The system of claim 7, wherein the audio context is a volume level of the speech indicative of tone.

11. The system of claim 7, wherein the audio context is a sentiment produced by a sentiment analysis engine.

12. The system of claim 7, wherein the visual form is captioned text speech recognized from the speech audio in the audio stream.

13. A computing device comprising a non-transitory computer readable storage medium having program instructions stored therein, the instructions being executable by at least one processing core of a processing unit to cause the processing unit to perform visual cueing of audio context in an assistive audio call for a hard of hearing (HOH) participant, by:
establishing an assistive call with an HOH participant and a counterpart participant;
receiving an audio stream from the counterpart participant and identifying speech audio within the audio stream;
submitting the speech audio to a speech transformation engine in order to transform the speech audio to a visual form of the speech for consumption by the HOH participant;
processing a portion of the audio stream separate from the transformation of the speech audio to the visual form in order to identify an audio context of the audio stream;
matching the audio context to a visual cue;
displaying the visual form in a user interface to the assistive audio call; and,
supplementing the visual form in the user interface with the visual cue of the audio context.

14. The device of claim 13, wherein the audio context is a determination of one of a masculine voice and a feminine voice.

15. The device of claim 13, wherein the audio context is a determination of a type of background noise.

16. The device of claim 13, wherein the audio context is a volume level of the speech indicative of tone.

17. The device of claim 13, wherein the audio context is a sentiment produced by a sentiment analysis engine.

18. The device of claim 13, wherein the visual form is captioned text speech recognized from the speech audio in the audio stream.
